(19) United States
(12) Patent Application Publication
(10) Pub. No.: US 2026/0117603 A1
(43) Pub. Date: Apr. 30, 2026

(54) Internally-Wound Stop Ring

(71) Applicant: Shaanxi Newland Industrial Co., Limited, WeiNan (CN)

(72) Inventors: Yuefeng ZHANG, WeiNan (CN); Beixing WANG, WeiNan (CN)

(73) Assignee: Shaanxi Newland Industrial Co., Limited, WeiNan (CN)

(21) Appl. No.: 19/006,836

(22) Filed: Dec. 31, 2024

(30) Foreign Application Priority Data
Oct. 30, 2024 (CN) 202411535175.2

(51) Int. Cl. E21B 33/14; E21B 17/10

(52) U.S. Cl. CPC E21B 17/042; E21B 17/10; E21B 33/14; F16L 19/02; F16L 19/065; E21B 17/16; F16L 2201/10

(57) ABSTRACT

An internally-wound stop ring is provided. The stop ring includes an inner ring and an outer ring connected internally and externally by threads. A wound inclined surface is provided at an end of an outer surface of the inner ring and has a cut-off groove. The outer surface of the inner ring is further provided with an external thread. Resistance-increasing annular teeth are provided at a position corresponding to the wound inclined surface on an inner surface of the inner ring. An end of the outer ring is provided with a hook spanner operating hole along a circumference of the outer ring. An inner surface of the outer ring is provided with an internal thread and a pressing inclined surface. The pressing inclined surface of the outer ring and the wound inclined surface of the inner ring are correspondingly in contact with and pressed against each other.

### CROSS-REFERENCE TO RELATED APPLICATION(S)

The disclosure claims the priority to Chinese Patent Application No. 202411535175.2, filed with the China National Intellectual Property Administration (CNIPA) on Oct. 30, 2024, which is hereby incorporated by reference in its entirety.

### FIELD

The disclosure belongs to the technical field of well cementing equipment in petroleum drilling and production, and relates to an internally-wound stop ring.

### BACKGROUND

In well cementing operations, it is necessary to losslessly install a fixing apparatus, i.e. a stop ring, on an outer side of a casing. The stop ring can ensure that attachments of the casing are firmly held at pre-installed positions without axial movement, thereby ensuring a high well cementing quality.

At present, the stop ring used on the market mostly adopts a jackscrew stop structure, and a large number of jackscrews need to be provided according to a clamping force requirement, and thus the on-site installation process is tedious, the operation time is long, the operation consistency is poor, the concentricity with the casing is poor, and the jackscrews cause different degrees of indentation on the casing, and there is also a risk that the jackscrews fall into the well during installation. the installation strength of the jackscrews by different operators is different, which may cause the installation of the stop ring to be not concentric with the casing; a casing centralizer is loaded with a biased force, which causes problems such as difficulty in lowering of the casing, low lowering speed, and insufficient centralization degree of the casing in a borehole during well cementing, thereby reducing the quality of well cementing, or affecting the quality of well cementing due to failed well cementing or oil-gas crossflow.

### SUMMARY

An object of the disclosure is to provide an internally-wound stop ring, so as to solve the problems of poor concentricity of a stop ring and easy fall-off of jackscrews in the related art. Some embodiments of the disclosure provide an internally-wound stop ring, including an inner ring and an outer ring connected internally and externally by threads, a wound inclined surface is provided at an end of an outer surface of the inner ring, the wound inclined surface is provided with a cut-off groove, the outer surface of the inner ring is further provided with an external thread, and resistance-increasing annular teeth are provided at a position corresponding to the wound inclined surface on an inner surface of the inner ring; an end of the outer ring is provided with a hook spanner operating hole along a circumference of the outer ring, and an inner surface of the outer ring is provided with an internal thread and a pressing inclined surface, respectively; and the internal thread of the outer ring is fitted with the external thread of the inner ring, the pressing inclined surface of the outer ring and the wound inclined surface of the inner ring are correspondingly in contact with and pressed against each other, and the pressing inclined surface and the wound inclined surface are tapered surfaces having a consistent taper.

In some embodiments, the outer surface of the inner ring is provided with the wound inclined surface and the hook spanner operating hole, the inner ring is provided with a plurality of hook spanner operating holes, and the plurality of hook spanner operating holes are uniformly arranged on the same circumference.

In some embodiments, the cut-off groove has a spiral track or a parallel track, and when the cut-off groove is a spiral track, the cut-off groove and the external threads have the same screwing direction.

In some embodiments, the cut-off groove has a single-head track, or a double-head track, or a multi-head track, and a strain notch is provided at a tail end where the cut-off groove is connected to the inner ring.

In some embodiments, a width of the cut-off groove is 0.5 mm-5 mm.

In some embodiments, the resistance-increasing annular teeth are continuous or discontinuous, and when the resistance-increasing annular teeth are discontinuous, a discontinuous notch is provided between two adjacent resistance-increasing annular teeth.

In some embodiments, tapers of the pressing inclined surface and the wound inclined surface are 5°-30°.

In some embodiments, one inner ring and two outer rings are provided, outer surfaces at two ends of the inner ring are both provided with the wound inclined surface, the pressing inclined surfaces of the two outer rings are in contact with and pressed against the two wound inclined surface of the inner ring, respectively, and the two outer rings are symmetrically arranged at the two ends of the inner ring.

In some embodiments, two inner rings and two outer rings are respectively provided, each of the two inner rings is fixedly connected to one outer ring, and the two outer rings are symmetrically distributed.

In some embodiments, the inner ring is made of an elastic material.

Advantageous effects of the disclosure are as follows:
regarding the problems that the on-site installation process of current stop ring used on the market is tedious, the operation time is long, the operation consistency is poor, the concentricity with the casing is poor, the jackscrew causes different degrees of indentation on the casing, the jackscrew easily falls off, the installation strength of the jackscrews by different operators is different, which causes the installation of the stop ring to be not concentric with the casing, and a casing centralizer is loaded with a biased force, which causes difficulty in lowering of the casing, low lowering speed, and insufficient centralization degree of the casing in a borehole during well cementing, the internally-wound stop ring of the disclosure adopts a winding clamping solution, which achieves a large clamping force, convenient and quick installation, good concentricity and a high product processing precision, effectively shortens the operation time and ensures a good well cementing quality.

### BRIEF DESCRIPTION OF DRAWINGS

FIG. 1 is a schematic structural diagram of an internally-wound stop ring according to Embodiment 2 of the disclosure;

FIG. 2 is a schematic structural diagram of an internally-wound bidirectional stop ring according to Embodiment 3 of the disclosure;

FIG. 3 is a schematic structural diagram of an internally-wound bidirectional stop ring according to Embodiment 4 of the disclosure;

FIG. 4 is a schematic structural diagram of an internally-wound stop ring according to Embodiment 5 of the disclosure;

FIG. 5 is a schematic structural diagram of an internally-wound stop ring according to Embodiment 6 of the disclosure;

FIG. 6 is a schematic structural diagram of an internally-wound stop ring according to Embodiment 7 of the disclosure;

FIG. 7 is a schematic structural diagram of an internally-wound stop ring according to Embodiment 8 of the disclosure; and

FIG. 8 is a schematic structural diagram of an internally-wound stop ring according to Embodiment 9 of the disclosure.

In the drawings: 1. Inner ring; 2. Outer ring; 3. Wound inclined surface; 4. Pressing inclined surface; 5. Resistance-increasing annular teeth; 6. Hook spanner operating hole; 7. Cut-off groove; 8. Strain notch; 9. Discontinuous notch.

### DESCRIPTION OF EMBODIMENTS

The disclosure will be described below in detail in conjunction with the accompanying drawings and specific embodiments.

### Embodiment 1

The present embodiment provides an internally-wound stop ring, including an inner ring 1 and an outer ring 2 connected internally and externally by threads, a wound inclined surface 3 is provided at an end of an outer surface of the inner ring 1, the wound inclined surface 3 is provided with a cut-off groove 7, the outer surface of the inner ring 1 is further provided with an external thread, and resistance-increasing annular teeth 5 are provided at a position corresponding to the wound inclined surface 3 on an inner surface of the inner ring 1, and the resistance-increasing annular teeth 5 are configured for increasing the friction; an end of the outer ring 2 is provided with a hook spanner operating hole 6 along a circumference of the outer ring 2, and an inner surface of the outer ring 2 is provided with an internal thread and a pressing inclined surface 4, respectively; and the internal thread of the outer ring 2 is fitted with the external thread of the inner ring 1, the pressing inclined surface 4 of the outer ring and the wound inclined surface 3 of the inner ring are correspondingly in contact with and pressed against each other, and the pressing inclined surface 4 and the wound inclined surface 3 are tapered surfaces having a consistent taper, tapers of the pressing inclined surface 4 and the wound inclined surface 3 are 5°, and the inner ring 1 is made of an elastic material to allow it to be elastically deformed and wound.

By screwing the outer ring 2 and the inner ring 1, the pressing inclined surface 4 on the inner side of the outer ring 2 is gradually in contact with the wound inclined surface 3 at the tail end of the inner ring 1, and the wound inclined surface 3 and a surface of a pipeline are sufficiently attached to each other by a rotary sliding action of the two contact surfaces and a pressing action of the two inclined surfaces; and at the same time, the resistance-increasing annular teeth 5 on the inner surface of the inner ring 1 penetrate into an outer surface of the pipeline, so as to achieve a clamping action.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 2

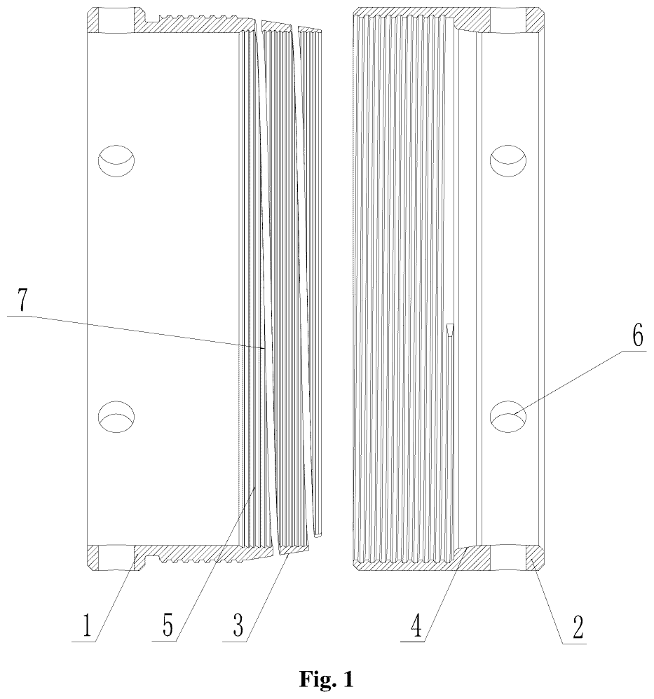

The present embodiment provides an internally-wound stop ring, as shown in FIG. 1, on the basis of Embodiment 1, the outer surface at one end of the inner ring 1 is provided with the wound inclined surface 3, and the other end thereof is provided with the hook spanner operating hole 6 along the circumference of the outer ring 2; the inner ring 1 is provided with a plurality of hook spanner operating holes 6, and the plurality of hook spanner operating holes 6 are uniformly arranged on the same circumference, and also of the outer ring 2 is also provided a plurality of hook spanner operating holes 6, and the plurality of hook spanner operating holes 6 are uniformly arranged on the same circumference.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 3

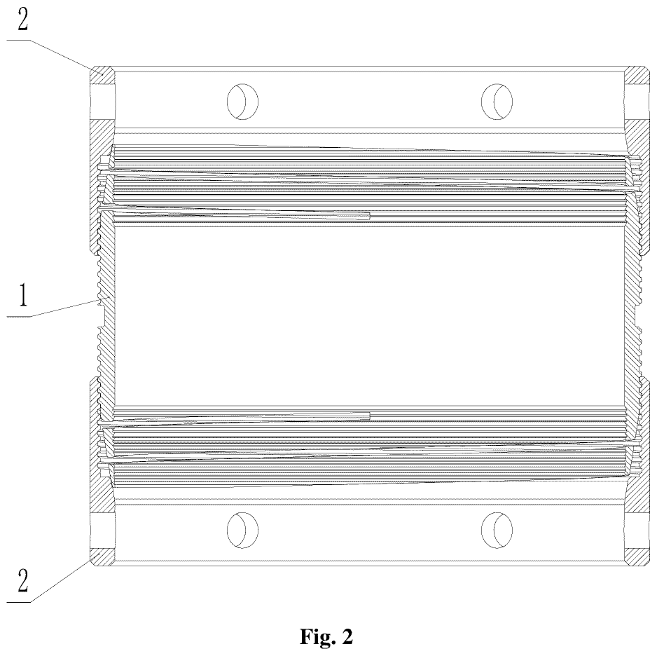

The present embodiment provides an internally-wound stop ring, as shown in FIG. 2, on the basis of Embodiment 1, one inner ring 1 and two outer rings 2 are provided, outer surfaces at two ends of the inner ring 1 are both provided with the wound inclined surface 3, the pressing inclined surfaces 4 of the two outer rings 2 are in contact with and pressed against the two wound inclined surfaces 3 of the inner rings 1, respectively, and tapers of the pressing inclined surfaces 4 and the wound inclined surfaces 3 are 30°, and the two outer rings 2 are symmetrically arranged at the two ends of the inner ring 1. By screwing the outer rings 2 at two ends of the inner ring 1, the wound inclined surfaces 3 which are annularly cut off and provided on the inner ring 1 are respectively contracted on the circumference and are gradually wound on a casing or pipeline, and at the same time, the resistance-increasing annular teeth 5 on the inner surface of the inner ring 1 are inserted into an outer surface of the casing or pipeline, thereby achieving bidirectional locking.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 4

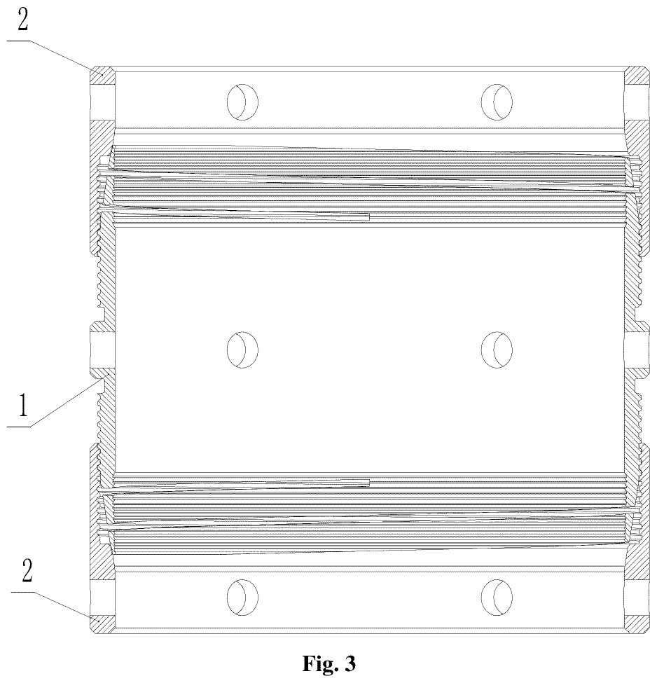

The present embodiment provides an internally-wound stop ring, as shown in FIG. 3, on the basis of Embodiment 3, a middle part of the outer surface of the inner ring 1 is provided with a plurality of hook spanner operating holes 6 along the circumference of the outer ring 2, and the plurality of hook spanner operating holes 6 are uniformly located on the same circumference.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 5

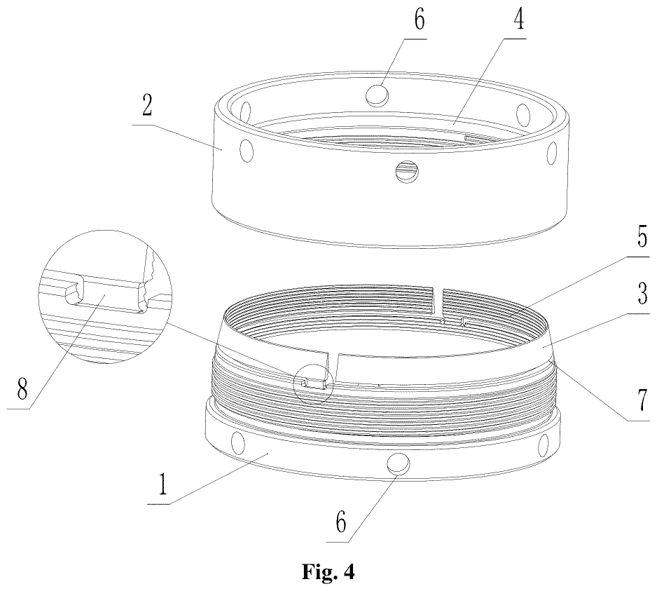

The present embodiment provides an internally-wound stop ring, as shown in FIG. 4, on the basis of Embodiment 2, the resistance-increasing annular teeth 5 are continuous; the cut-off groove 7 has a parallel track, and the cut-off groove 7 has a multi-head track, a width of the cut-off groove 7 is 0.5 mm, a strain notch 8 is provided at a tail end where the cut-off groove 7 is connected to the inner ring 1, and during a process of locking, the stress notch 8 is deformed, which is more beneficial for locking of the inner ring 1.

The inner ring 1 is screwed to pass through the pressing inclined surfaces 4 of the outer rings 2, such that the annular cut-off wound inclined surface 3 on the inner ring 1 is contracted on the circumference and is gradually wound on a casing or pipeline, and at the same time, the resistance-increasing annular teeth 5 on the inner surface of the inner ring 1 are inserted into an outer surface of the casing or pipeline.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 6

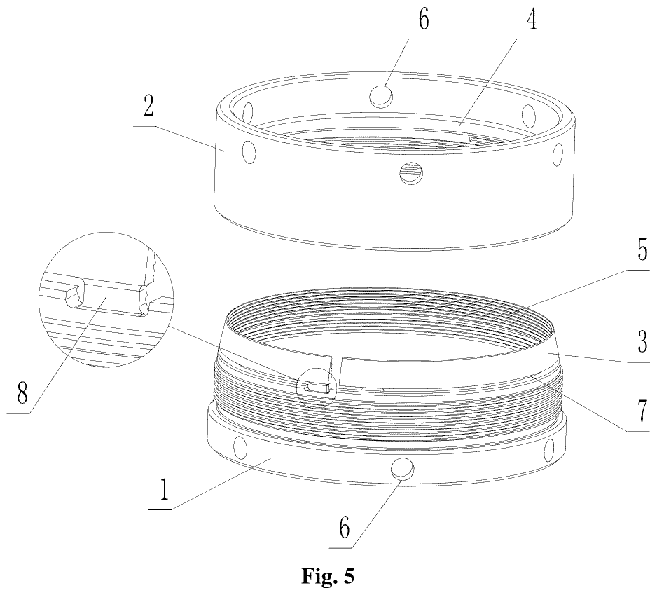

The present embodiment provides an internally-wound stop ring, as shown in FIG. 5, on the basis of Embodiment 2, the resistance-increasing annular teeth 5 are continuous; the cut-off groove 7 is set to have a single head, the cut-off groove 7 has a parallel track, a width of the cut-off groove 7 is 5 mm, a strain notch 8 is provided at a position where the cut-off groove 7 is connected to the inner ring 1, and during a process of locking, the stress notch 8 is deformed, which is more beneficial for locking of the inner ring 1; an end surface of the outer ring 2 is uniformly provided with a plurality of hook spanner operating holes 6 for installation, and the internal thread and the pressing inclined surface 4 are provided inside the outer ring 2; and the inner ring 1 is screwed to pass through the pressing inclined surface 4 of the outer ring 2, such that the annular cut-off wound inclined surface 3 on the inner ring 1 is contracted on the circumference and is gradually wound on a casing or pipeline, and at the same time, the resistance-increasing annular teeth 5 on the inner surface of the inner ring 1 are inserted into an outer surface of the casing or pipeline. The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 7

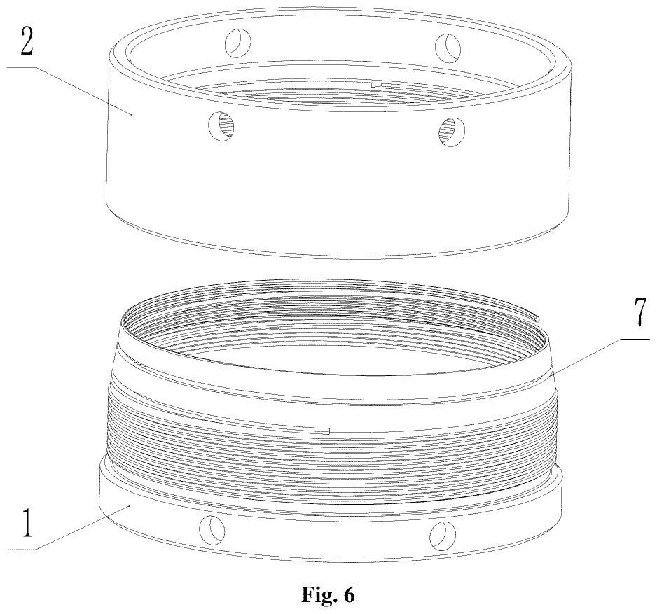

The present embodiment provides an internally-wound stop ring, as shown in FIG. 6, on the basis of Embodiment 2, the cut-off groove 7 is set to have a single head, the cut-off groove 7 is set to have a spiral track, the cut-off groove 7 and the external thread have the same screwing direction, and a width of the cut-off groove 7 is 2.5 mm; and the inner ring 1 is screwed to pass through the pressing inclined surfaces of the outer rings 2, such that the cut-off wound inclined surface 3 on the inner ring 1 is contracted on the circumference and is gradually wound on a casing or pipeline.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 8

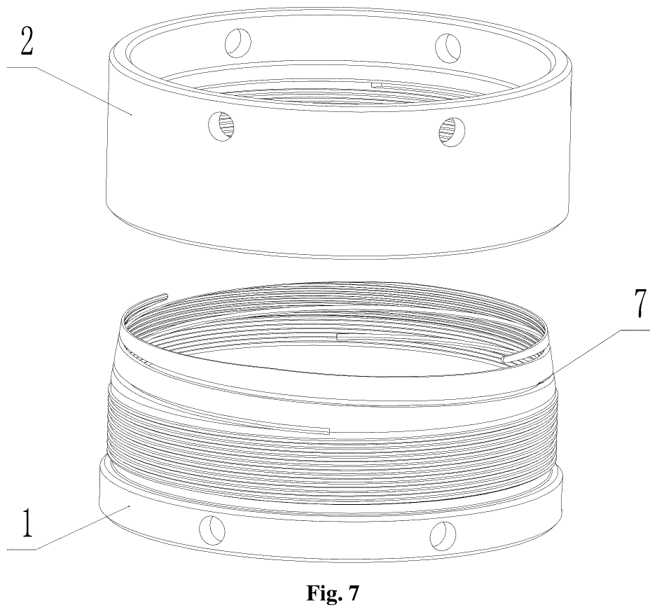

The present embodiment provides an internally-wound stop ring, as shown in FIG. 7, on the basis of Embodiment 2, The cut-off groove 7 is set to have double heads, the cut-off groove 7 is set to have a spiral track, and the cut-off groove 7 and the external thread have the same screwing direction; and the inner ring 1 is screwed to pass through the pressing inclined surfaces of the outer rings 2, such that the cut-off wound inclined surface 3 on the inner ring 1 is contracted on the circumference and is gradually wound on a casing or pipeline.

The embodiment merely represents preferred embodiments of the internally-wound stop ring in the disclosure, and any internally-wound stop ring designed with technical features similar to those of the disclosure shall fall within the scope of protection of the internally-wound stop ring of the disclosure.

### Embodiment 9

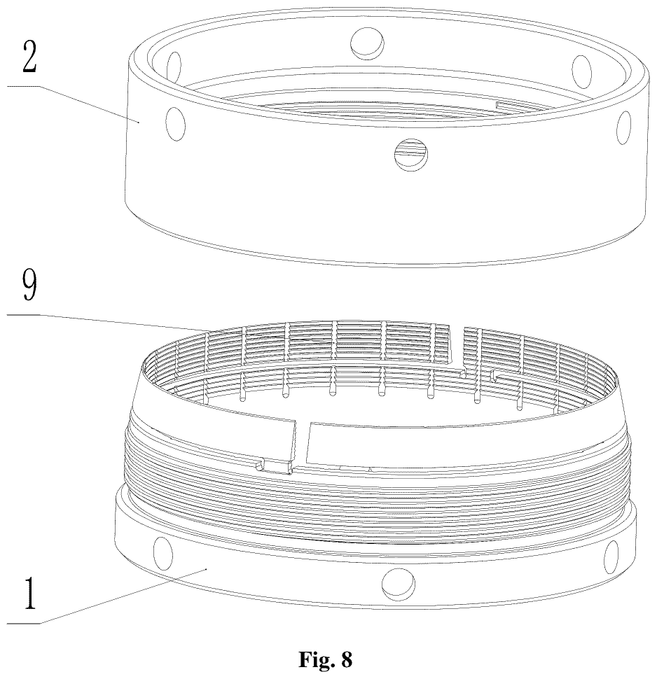

The present embodiment provides an internally-wound stop ring, as shown in FIG. 8, on the basis of Embodiment 2, The resistance-increasing annular teeth 5 are discontinuous, and a discontinuous notch 9 is provided between two adjacent resistance-increasing annular teeth 5; and the inner ring 1 is screwed to pass through the pressing inclined surfaces of the outer rings 2, and the resistance-increasing discontinuous teeth provided in the cut-off wound inclined surface 3 on the inner ring 1 are easier to wind around and penetrate into a casing or pipeline, thereby providing a better locking effect.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

### Embodiment 10

The present embodiment provides an internally-wound stop ring, on the basis of Embodiment 1, two inner rings 1 and two outer rings 2 are respectively provided, and each of the two inner rings 1 is fixedly connected to one outer ring 2, that is, the pressing inclined surface 4 of one outer ring 2 is in contact with and pressed against the wound inclined surface 3 of a corresponding inner ring 1, tapers of the pressing inclined surface 4 and the wound inclined surface 3 are 15°; and the two outer rings 2 are symmetrically distributed, and the two inner rings 1 and the two outer rings 2 form an integral combination, which provides a greater clamping force in two directions.

The embodiment merely represents a specific embodiment of the internally-wound stop ring in the disclosure, and any internally-wound stop ring designed with technical features similar to those of the disclosure shall fall within the scope of protection of the internally-wound stop ring of the disclosure.

1. An internally-wound stop ring, comprising an inner ring and an outer ring connected internally and externally by threads, wherein a wound inclined surface is provided at an end of an outer surface of the inner ring, the wound inclined surface is provided with a cut-off groove, the outer surface of the inner ring is further provided with an external thread, and resistance-increasing annular teeth are provided at a position corresponding to the wound inclined surface on an inner surface of the inner ring; an end of the outer ring is provided with a hook spanner operating hole along a circumference of the outer ring, and an inner surface of the outer ring is provided with an internal thread and a pressing inclined surface, respectively; and the internal thread of the outer ring is fitted with the external thread of the inner ring, the pressing inclined surface of the outer ring and the wound inclined surface of the inner ring are correspondingly in contact with and pressed against each other, and the pressing inclined surface and the wound inclined surface are tapered surfaces having a consistent taper.

2. The internally-wound stop ring according to claim 1, wherein the outer surface of the inner ring is provided with the wound inclined surface and the hook spanner operating hole, the inner ring is provided with a plurality of hook spanner operating holes, and the plurality of hook spanner operating holes are uniformly arranged on the same circumference.

3. The internally-wound stop ring according to claim 1, wherein the cut-off groove has a parallel track.

4. The internally-wound stop ring according to claim 3, wherein a strain notch track is provided at a tail end where the cut-off groove is connected to the inner ring.

5. The internally-wound stop ring according to claim 1, wherein a width of the cut-off groove is 0.5 mm-5 mm.

6. The internally-wound stop ring according to claim 1, wherein the resistance-increasing annular teeth are continuous or discontinuous, and when the resistance-increasing annular teeth are discontinuous, a discontinuous notch (9) is provided between two adjacent resistance-increasing annular teeth.

7. The internally-wound stop ring according to claim 1, wherein tapers of the pressing inclined surface and the wound inclined surface are 5°-30°.

8. The internally-wound stop ring according to claim 1, wherein one inner ring and two outer rings are provided, outer surfaces at two ends of the inner ring are both provided with the wound inclined surface, the pressing inclined surfaces of the two outer rings are in contact with and pressed against the two wound inclined surface of the inner ring, respectively, and the two outer rings are symmetrically arranged at the two ends of the inner ring.

9. The internally-wound stop ring according to claim 2, wherein two inner rings and two outer rings are respectively provided, each of the two inner rings is fixedly connected to one outer ring, and the two outer rings are symmetrically distributed.

10. The internally-wound stop ring according to claim 1, wherein the inner ring is made of an elastic material.
